(19) United States
(12) Patent Application Publication
(10) Pub. No.: US 2017/0298819 A1
(43) Pub. Date: Oct. 19, 2017

(54) TURBINE IMPELLER

(71) Applicant: Honda Motor Co.,Ltd., Tokyo (JP)

(72) Inventors: Naoki KUNO, Saitama (JP); Naoki ITOH, Saitama (JP)

(73) Assignee: Honda Motor Co.,Ltd., Tokyo (JP)

(21) Appl. No.: 15/490,867

(22) Filed: Apr. 18, 2017

(30) Foreign Application Priority Data
Apr. 19, 2016 (JP) 2016-083767

(51) Int. Cl. F02C 6/12; F04D 25/04; F01D 5/14

(52) U.S. Cl. CPC F02C 6/12; F01D 5/147; F04D 25/04

(57) ABSTRACT

A turbine impeller supplies a high-pressure fluid through a scroll flow route and/or a exhaust supply port of a fixed nozzle and includes: blade components converting the fluid into a rotational force; and a rotor, configured with the blade components and can rotate around a specified rotational axis, wherein a direction, relative to a gas relative inflow velocity of the rotor, specified by using the fluid supply port as a starting point and subtracting a rotational velocity component of the rotor from a supply velocity component of the fluid is set to not intersect with the rotational axis of the rotor; and a shape, from a halfway portion to a front edge portion, of the blade component inclines, relative to a direction from a center of the rotor to an upstream portion of the blade component, toward front side of a rotating direction of the rotor by a specified angle.

### CROSS-REFERENCE TO RELATED APPLICATION

This application claims the priority benefit of Japan application serial no. 2016-083767, filed on Apr. 19, 2016. The entirety of the above-mentioned patent application is hereby incorporated by reference herein and made a part of this specification.

### BACKGROUND OF THE INVENTION

### 1. Field of the Invention

The present invention relates to a turbine impeller.

### 2. Description of Related Art

In the past, as a turbine impeller mounted in a flow route of an internal combustion engine (hereinafter referred to as an engine), the following turbine impeller is known: the turbine impeller is formed in manner of making an orientation of a front end shape of a blade of the turbine impeller consistent to an inflow direction of a gas relative inflow velocity V of a velocity triangle as follows, and the velocity triangle is formed by an inflow velocity C of exhaust that flows into an inlet of a movable blade, a rotational velocity U of the movable blade in a circumferential direction, and the gas relative inflow velocity V (for example, refer to patent document 1).

### PRIOR ART DOCUMENT

### Patent Document

[Patent document 1] JP Patent Publication No. 2011-132810

### SUMMARY OF THE INVENTION

### Problems to be Resolved by the Present Invention

However, a shape of a blade front end of an existing turbine impeller has the following problem: in a case in which an inflow velocity of exhaust changes to an intermediate velocity or low velocity, it is difficult to ensure a proper angle of attack, and the energy conversion efficiency is unfavorable.

In view of the problem, the present invention is provided and is directed to providing a turbine impeller that ensures a proper angle of attack for exhaust having a broad velocity zone and that has high turbine energy conversion efficiency.

### Technical Means for Resolving the Problems

(1) A turbine impeller is a turbine impeller (for example, the turbine impellers 5, 205 as stated in the following) that supplies a high-pressure fluid through a turbine scroll (for example, a scroll flow route 42 as stated in the following) and/or a fluid supply port (for example, an exhaust supply port 49 as stated in the following) of a turbine nozzle (for example, a fixed nozzle 46 as stated in the following) and includes: a plurality of blade components (for example, blade components 60, 260 as stated in the following), which converts the fluid into a rotational force; and a rotor (for example, a rotor 80 as stated in the following), which is configured with the blade components and can rotate around a specified rotational axis, where: a direction, relative to a gas relative inflow velocity (for example, a gas relative inflow velocity V as stated in the following) of the rotor, specified by using the fluid supply port as a starting point and subtracting a rotational velocity component (for example, a rotating velocity U of the rotor as stated in the following) of the rotor from a supply velocity component (for example, an inflow velocity C of exhaust as stated in the following) of the fluid is set to not intersect with the rotational axis of the rotor; and a shape, from a halfway portion (for example, a halfway portion 64 as stated in the following) to a front edge portion (for example, a front end 62 as stated in the following), of the blade component inclines, relative to a direction from a center (for example, a center Co stated in the following) of the rotor to a front edge portion of the blade component, toward front side of a rotational direction of the rotor by a specified angle (for example, an angle α as stated in the following).

With regard to the turbine impeller of (1), an angle of inclination from the halfway portion to the front edge portion is adjusted to make an angle of attack of exhaust that collides with the blade component become proper. In addition, with regard to the turbine impeller of (1), a turbine impeller that has a proper angle of attack for exhaust of different velocity zones can be formed by adjusting the angle of inclination of the inclined blade.

Hence, because of a structural limitation, an existing turbine impeller cannot be designed with an angle of attack suitable for exhaust having a broad velocity zone from a low velocity to a high velocity. However, a turbine impeller of the present implementation manner can ensure a proper angle of attack for exhaust having a velocity zone from a low velocity to an intermediate velocity or from an intermediate velocity to a high velocity. As a result, a turbine impeller having high energy conversion efficiency can be provided.

(2) According to the turbine impeller of (1), an angle at which the fluid flows into the blade component inclines by 10 degrees to 40 degrees relative to an angle formed between the gas relative inflow velocity and exhaust supplied by the exhaust supply port.

According to the turbine impeller of (1), with regard to the turbine impeller of (2), in particular, an angle at which exhaust flows into the blade component is set in a manner of inclining by 10 degrees to 40 degrees relative to an angle formed between the gas relative inflow velocity and the exhaust supplied by the exhaust supply port, so that a turbine impeller designed in a manner of achieving a proper angle of attack under a range of a low velocity to an intermediate velocity can be provided.

Therefore, a turbine impeller having high energy conversion efficiency for exhaust having a flow rate ranging from a low velocity to an intermediate velocity can be provided.

(3) According to the turbine impeller of (1) or (2), a sectional shape of the front edge portion of the blade component is an elliptical arc shape.

According to the turbine impeller of (1) or (2), in the turbine impeller of (3), in particular, each front edge portion is formed into an approximately circular shape with smooth curvature.

Hence, an exciting force that is formerly generated in a nozzle wake of a fixed nozzle can be properly distributed by using a front end of the front edge portion.

Therefore, a turbine impeller that prevents a defect of the blade component caused by resonance of the nozzle wake and that gives consideration to both strength and aerodynamic performance of the blade component can be provided.

(4) According to the turbine impeller of (3), a round corner that has a section in a circular arc shape and that smoothly connects a lateral surface of the blade component and a blade hub surface (for example, a blade hub surface 81 as stated in the following) of the rotor is formed at a blade root of the front edge portion of the blade component; and the thickness of the blade component progressively reduces from the rotor side to an edge of a thin sheet side (for example, shroud sides 262B, 266B as stated in the following).

According to the turbine impeller of (3), in the turbine impeller of (4), in particular, the round corner is formed at the blade root of the front edge portion, and the thickness of the blade component is formed in a manner of progressively reducing from the rotor side to the edge of the thin sheet side edge.

Hence, the front edge portion can further distribute the exciting force of the nozzle wake.

Therefore, an effect of (3) can be produced more specifically.

### Effects of the Invention

According to the present invention, a turbine impeller that ensures a proper angle of attack for exhaust having a broad velocity zone and that has high turbine energy conversion efficiency can be provided.

### BRIEF DESCRIPTION OF THE DRAWINGS

FIG. 1 is a sectional view illustrating a structure of a supercharger according to an implementation manner of the present invention;

FIG. 2 is a schematic diagram of a section along an A-A line in FIG. 1;

FIG. 3 is a front view of a turbine impeller according to the present implementation manner;

FIG. 4 is a three-dimensional diagram of a turbine impeller according to the present implementation manner;

FIG. 5 is a three-dimensional diagram of a turbine impeller according to the present implementation manner;

FIG. 6 is a diagram for explaining a function of a turbine impeller according to the present implementation manner;

FIG. 7 is a front view of an existing turbine impeller;

FIG. 8 is a diagram for explaining a velocity triangle of an existing example;

FIG. 9 is a diagram for explaining a velocity triangle according to the present implementation manner;

FIG. 10(A) and FIG. 10(B) are diagrams for explaining a velocity triangle of an existing example;

FIG. 11(A) and FIG. 11(B) are diagrams for explaining a velocity triangle according to the present implementation manner;

FIG. 12(A) and FIG. 12(B) are diagrams for explaining a velocity triangle of an existing example;

FIG. 13(A) and FIG. 13(B) are diagrams for explaining a velocity triangle according to the present implementation manner;

FIG. 14(A) and FIG. 14(B) are three-dimensional diagrams for illustrating a modified example of a front edge portion of a turbine impeller according to the present implementation manner; and

FIG. 15 is a diagram for explaining a function of the turbine impeller in FIG. 14.

### DESCRIPTION OF THE EMBODIMENTS

An implementation manner of the present invention is explained in detail below with reference to the accompanying drawings.

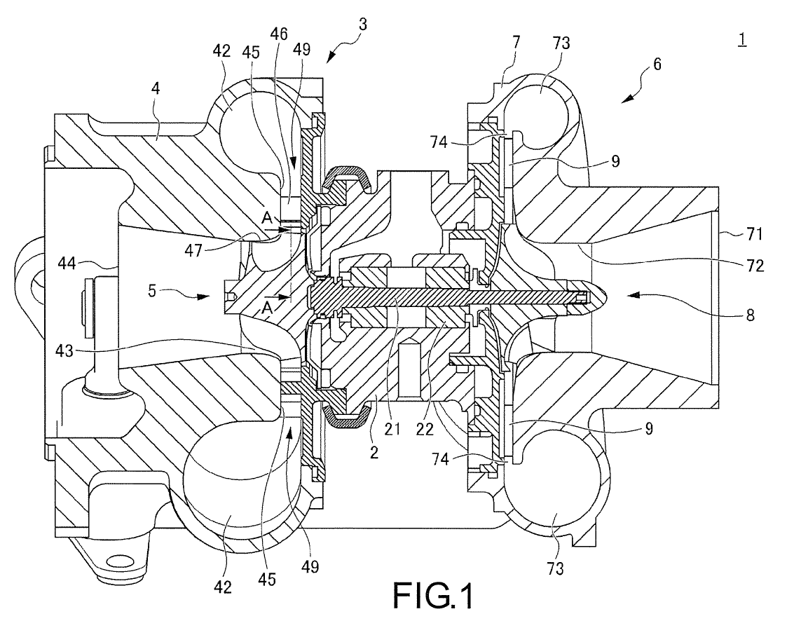

FIG. 1 is a sectional view illustrating a supercharger according to an implementation manner.

A supercharger 1 of the present invention includes a bearing housing 2, a turbine 3 mounted on an end side of the bearing housing 2, and a compressor 6 mounted on another end side of the bearing housing 2.

The bearing housing 2 includes a rod-shaped rotary shaft 21, extending between the turbine 3 and the compressor 6; and a bearing 22, rotatably supporting the rotary shaft 21.

The compressor 6 includes a compressor housing 7 that constitutes a part of an air intake channel of an internal combustion engine, a compressor impeller 8 disposed inside the compressor housing 7, and a diffuser 9.

A ring-shaped compressor impeller chamber 72, a circular ring-shaped scroll flow route 73, and a circular ring-shaped air intake flow route 74 are formed inside the compressor housing 7, an inlet air suction portion 71 connected to an air intake pipe (not shown in the drawing) of the internal combustion engine is formed on a front end side of the ring-shaped compressor impeller chamber 72, the circular ring-shaped scroll flow route 73 is formed in a manner of surrounding the compressor impeller chamber 72, and the circular ring-shaped air intake flow route 74 makes a base end side of the compressor impeller chamber 72 in communication with the scroll flow route 73.

The compressor impeller 8 is rotatably disposed inside the compressor impeller chamber 72 in a state of being connectable to another end side of the rotary shaft 21.

The diffuser 9 is in a circular disc shape and disposed in the air intake flow route 74. The diffuser 9 reduces inlet air injected from the base end side of the compressor impeller chamber 72 along a centrifugal direction of the rotary shaft 21 toward the scroll flow route 73, so as to compress the inlet air.

In addition, a turbine impeller 5 is integrally formed on an end of the rotary shaft 21, and the turbine impeller 5 is located inside a turbine impeller chamber 43 and serves as a main part of the turbine 3.

The turbine 3 of the supercharger 1, specifically, the turbine impeller chamber 43, is connected to the midway of the air intake channel of the engine (the air intake channel of the internal combustion engine).

A scroll flow route 42 is formed inside the turbine impeller chamber 43, and the scroll flow route 42 includes an exhaust suction port that is not shown in the drawing on an end. A circular ring-shaped exhaust channel in a state of surrounding an outer circumference of the turbine impeller 5 is integrally mounted on an inner circumferential side of the scroll flow route 42 (between the scroll flow route 42 and the turbine impeller chamber 43 configured with the turbine impeller 5).

The exhaust discharged from the engine through the exhaust suction port, not shown in the drawing, of the turbine 3, passes through the scroll flow route 42 and an exhaust supply channel 45 and is supplied to turbine the impeller chamber 43 through an exhaust supply port 49, so as to enable the turbine impeller 5 to rotate. Rotation of the turbine impeller 5 is transferred to the compressor impeller 8 through the rotary shaft 21, so as to enable the compressor impeller 8 to rotate. Because the compressor impeller 8 rotates, compressed air is supplies to the engine, and the supercharger 1 utilizes exhaust energy to supercharge the inlet air.

The exhaust supply channel 45 of the turbine 3 is delimited by a shroud portion 47 on an exhaust inlet side of the turbine impeller chamber 43, and the shroud portions 47 are spaced by a specified gap and opposite to each other in an axial direction. The shroud portion 47 is fixedly mounted in the bearing housing 2 or the turbine impeller chamber 43.

The exhaust that flows from the scroll flow route 42 to the fixed nozzle 46 is applied with a whirling force after acceleration when passing through the scroll flow route 42, and after forming a high-velocity air flow toward a radial direction inner side, is supplied from the exhaust supply port 49 to the turbine impeller 5. Whirling energy possessed by the high-velocity air flow is obtained as rotational energy by the turbine impeller 5. Then, the exhaust is discharged from a discharge portion 44 of the turbine impeller chamber 43.

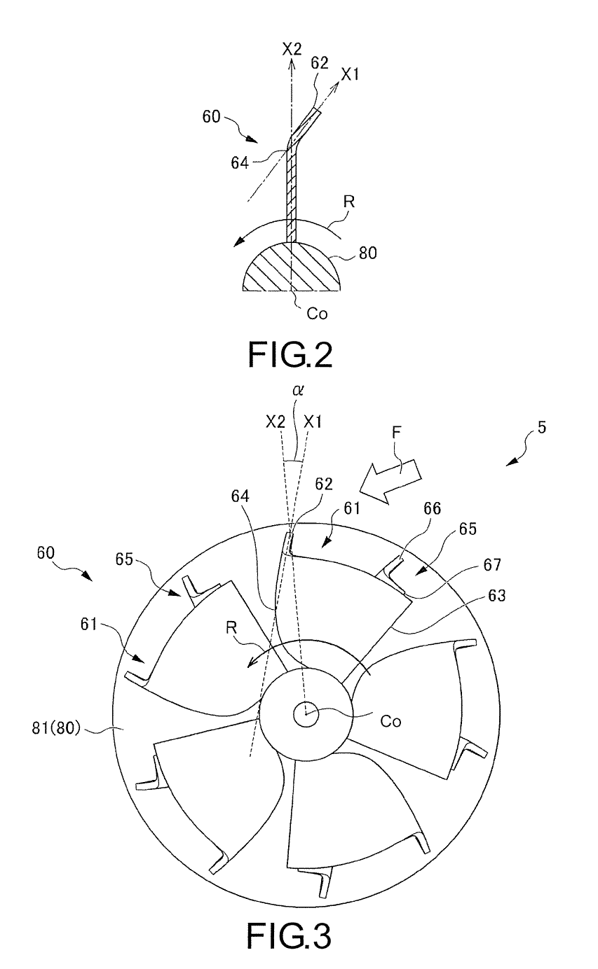

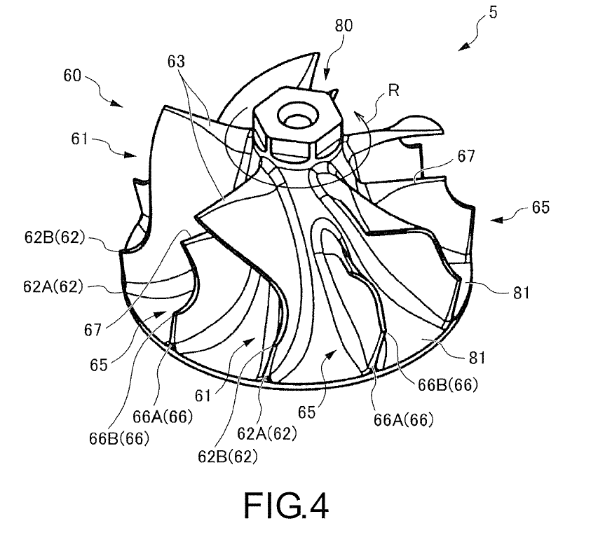

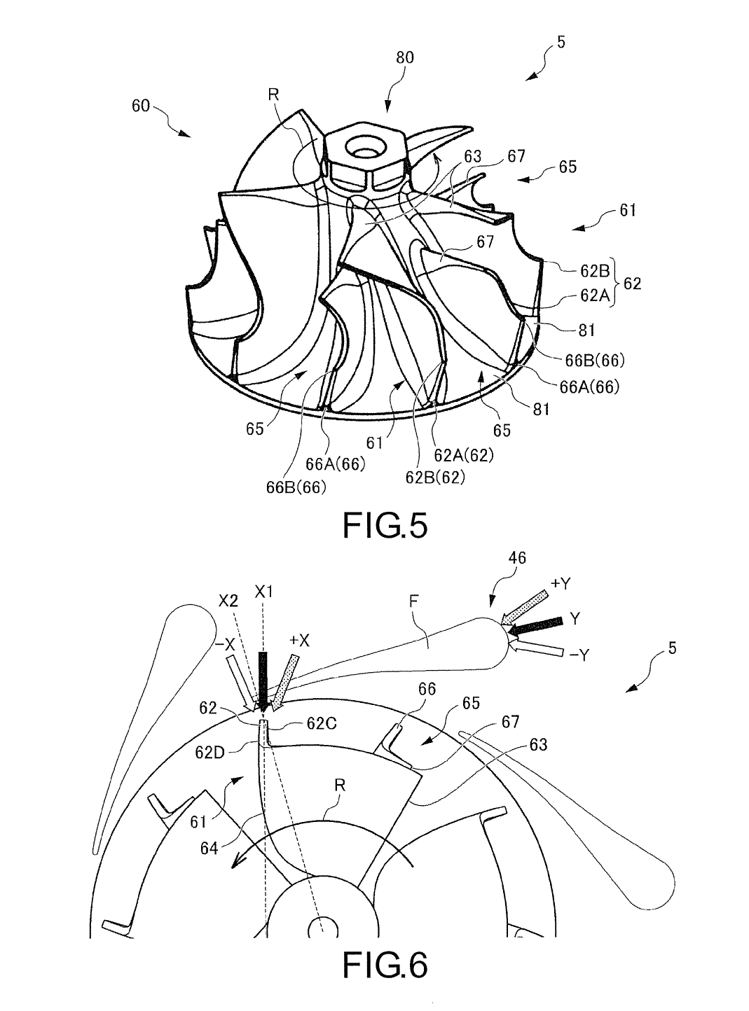

The turbine impeller 5 of the present implementation manner is explained below with reference to the accompanying drawings. FIG. 2 shows a section along an A-A line in FIG. 1. FIG. 3 is a front view of the turbine impeller 5 according to the present implementation manner. FIG. 4 and FIG. 5 are three-dimensional diagrams of the turbine impeller 5 according to the present implementation manner. FIG. 6 is a diagram for explaining a function of the turbine impeller 5 according to the present implementation manner.

As shown in FIG. 2 to FIG. 6, the turbine impeller 5 is formed by including a plurality of blade components 60 and a rotor 80 configured with the plurality of blade components 60 around. The turbine impeller 5 rotates by means of exhaust F at a specified velocity supplied by an exhaust supply port 49.

The blade component 60 is a plate-shaped component and is vertically disposed on a blade hub surface 81 of the rotor 80.

The blade component 60 includes a plurality of main blades 61, vertically disposed on the blade hub surface 81 and formed on a whole area between the blade hub surface 81 and an inner circumferential surface (refer to FIG. 1) of the shroud portion 47 of the turbine impeller chamber 43; and an intermediate blade 65, configured between main blades 61 that are adjacent to each other along a circumferential direction, where the length of the intermediate blade 65 is less than that of the main blade 61.

The main blade 61 is provided with a front edge portion 62 located on an upstream side in a flowing direction of exhaust and a rear edge portion 63 located on a downstream side in the flowing direction of the exhaust. As shown in FIG. 3, a smoothly bulged curve is formed from the rear edge portion 63 to the front edge portion 62. As shown in FIG. 4, a line that connects a blade hub surface side 62A and a shroud side 62B on an upstream side of the front edge portion 62 is parallel to a direction of a rotary shaft of the rotor 80.

The shape of a front edge portion 66 of the intermediate blade 65 is the same as that of the front edge portion 62 of the main blade 61, and a length from the front edge portion 66 of the intermediate blade 65 to a rear edge portion 67 thereof is less than a length form the front edge portion 62 of the main blade 61 to the rear edge portion 63 thereof. As compared with the rear edge portion 63 of the main blade 61, the rear edge portion 67 of the intermediate blade 65 is formed on back side in a rotational direction R of the rotor 80.

A direction X1 from a halfway portion 64 of the main blade 61 toward the front edge portion 62 is, for example, set in the following manner: that is, as shown in FIG. 2, as compared with a radial direction X2 from a center Co of the rotor 80 toward the front edge portion 62, inclining toward front side of the rotational direction R of the rotor 80 by an angle α. Hence, the direction X1 from the halfway portion 64 toward the front edge portion 62 would not intersect with a rotary shaft of the rotor 80.

In addition, as shown in FIG. 6, a pressurizing surface 62C that performs pressurization to an outer circumferential direction as the rotor 80 rotates is formed on the proximal front side of the rotational direction R of the rotor 80 in the front edge portion 62 of the main blade 61. In addition, a negative pressure surface 62D that performs suction to an inner circumferential direction is formed on an inner side of the rotational direction R of the rotor 80 in the front edge portion 62.

Exhaust F supplied from the fixed nozzle 46 to a Y direction expands toward a plus incidence direction (+Y) because of pressure from the pressurizing surface 62C. On the other hand, the exhaust F is pulled toward a minus incidence direction (−Y) because of pressure from the negative pressure surface 62D. According to the fluid distribution, the exhaust F that moves forward along the rotational direction R collides with the front edge portion 62 at a specified position. At this time, the exhaust F includes a component that performs collision from plus incidence (+X) side to a component that performs collision from minus incidence (−X) side with respect to an extending direction (X1) of the front edge portion 62.

In this way, the exhaust F supplied by the fixed nozzle 46 keeps specified fluid distribution and collides with the main blade 61 and the intermediate blade 65 at a specified incidence angle.

Moreover, for a shape of a front edge portion 62 of each blade component of the turbine impeller 5 of the present implementation manner, the angle α is adjusted in a manner of forming a proper angle of attack relative to exhaust F having different velocity zones. Particularly, in the present implementation manner, exhaust F of a low velocity to an intermediate velocity is properly converted by the turbine impeller 5 to rotational energy.

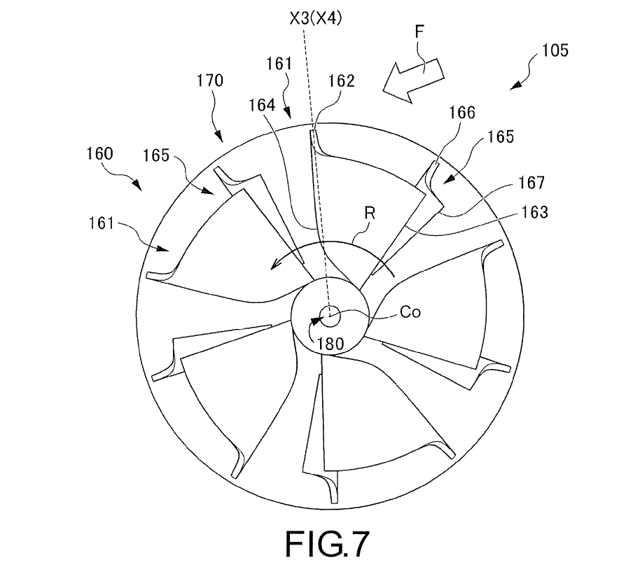

In the following, on the one side, an existing turbine impeller 105 including a radial blade 160 shown in FIG. 7 is used for comparison, and on the other side, a function of the turbine impeller 5 having the foregoing structure of the present implementation manner is explained.

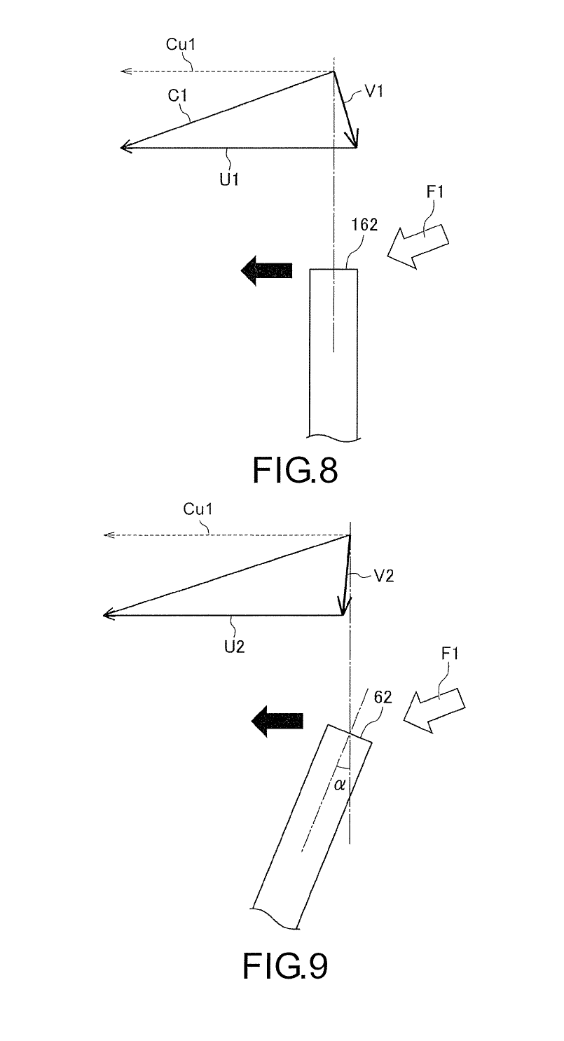

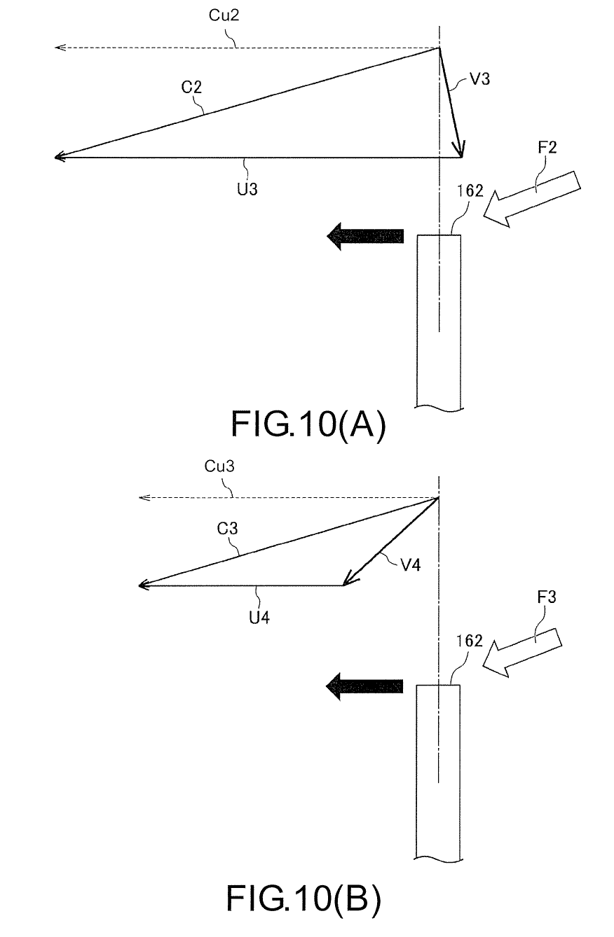

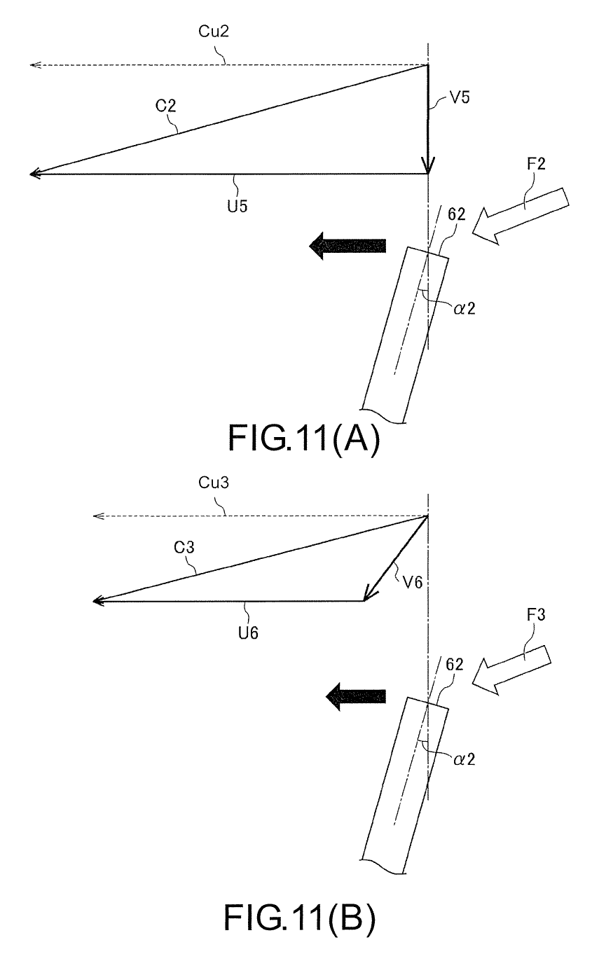

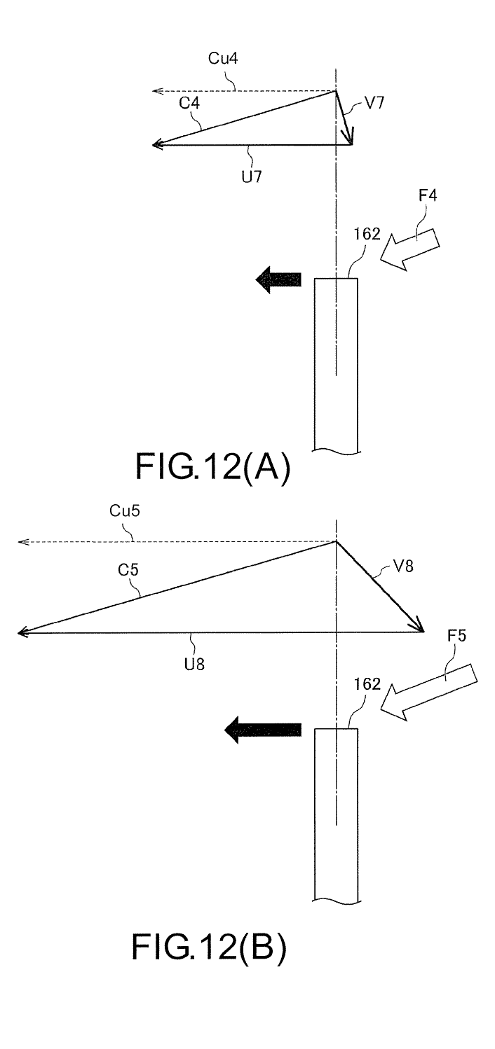

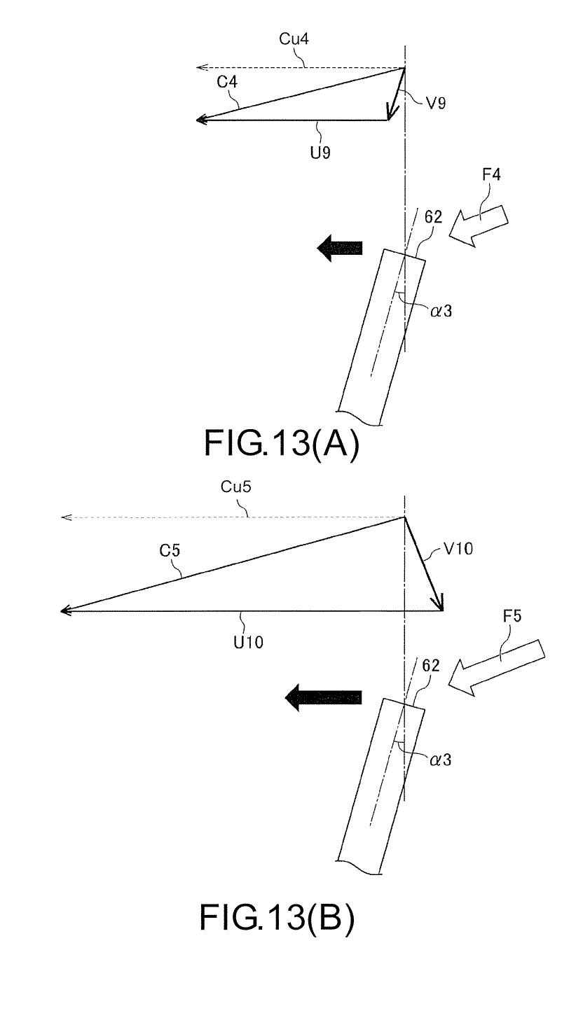

Herein, FIG. 7 is a front view of an existing turbine impeller. FIG. 8 is a diagram for explaining a velocity triangle of an existing turbine impeller. FIG. 9 is a diagram for explaining a velocity triangle of the turbine impeller 5 according to the present implementation manner. FIG. 10(A) and FIG. 10(B) are diagrams for explaining a velocity triangle of the existing turbine impeller 105. FIG. 11(A) and FIG. 11(B) are diagrams for explaining a velocity triangle of the turbine impeller 5 according to the present implementation manner. FIG. 12(A) and FIG. 12(B) are diagrams for explaining a velocity triangle of the existing turbine impeller 105. FIG. 13(A) and FIG. 13(B) are diagrams for explaining a velocity triangle of the turbine impeller 5 according to the present implementation manner.

First, the same as the blade component 60 (hereinafter referred to as an inclined blade), an existing blade component 160 (hereinafter referred to as a radial blade) is disposed on a rotor 180. The shape of the radial blade 160, from a halfway portion 164 to a front edge portion 162, is set to be approximately planar. Hence, a direction X3 from the halfway portion 164 toward the front edge portion 162 is set to be parallel to a radial direction X4 of the rotor 180.

As shown in velocity triangles of FIG. 8 and FIG. 9, when separately colliding with the inclined blade 60 and the radial blade 160 at a same velocity at a same angle, exhaust F supplied from an exhaust supply port not shown in the drawing has different incidence angles.

Herein, the “velocity triangle” specified in the present invention, for example, as shown in FIG. 8 and FIG. 9, indicates a cross correlation of a velocity, and the cross correlation of a velocity includes an exhaust inflow velocity C, a rotational velocity U of a blade component in a circumferential direction, and a gas relative inflow velocity V in a direction of flowing to a rotor.

The velocity triangle shown in FIG. 8 indicates obtaining a magnitude and an angle of a gas relative inflow velocity V1 according to an inflow velocity (a supply velocity) C1 of exhaust F1 supplied from an exhaust supply port not shown in the drawing to the radial blade 160 and a rotational velocity U1 of the radial blade 160.

Similarly, the velocity triangle shown in FIG. 9 indicates obtaining a magnitude and an angle of a gas relative inflow velocity V2 according to an inflow velocity (a supply velocity) C1 of exhaust F1 supplied from an exhaust supply port not shown in the drawing to the inclined blade 60 and a rotational velocity U2 of the inclined blade 60.

The gas relative inflow velocity V2, as compared with the gas relative inflow velocity V1, further inclines to a direction of an angle of attack with regard to exhaust F1 supplied at a same velocity at a same angle. Hence, as compared with the radial blade 160, the inclined blade 60 has an increased workload.

A workload W per unit of displacement of the impeller is represented by the following equation:

W=U_{B}·Cu_{B}−U_{A}·Cu_{A} [Equation 1]

Herein, U is a rotational velocity of a rotor, and Cu is a velocity component of exhaust in a circumferential direction. In addition, A indicates using a front edge portion of a blade component as a reference positions and B indicates using a rear edge portion of a blade component as a reference position.

The existing radial blade 160 utilizes a velocity component in circumferential direction/a rotational velocity of a rotor (Cu1/U1) as an indicator for improving working efficiency of the radial blade 160. Generally, the Cu1/U1=about 0.92, which is set to be an efficiency peak. With regard to the efficiency peak, when the front edge portion of the impeller blade is inclined by about −10 degrees to about −40 degrees, an optimal angle of attack is achieved.

However, to reduce a centrifugal stress when the rotor 180 rotates, a shape of the existing radial blade 160 is limited in a manner of making a direction from the halfway portion 164 to the front edge portion 162 consistent with a centrifugal (radial) direction. Therefore, the existing radial blade 160 cannot adjust a relationship between the velocity component Cu1 of the exhaust F in the circumferential direction and the rotational velocity U1 of the rotor 180 to be Cu1<U1.

In contrast, for the inclined blade 60 of the present implementation manner, even if the velocity component Cu1 of exhaust F in the circumferential direction is greater than the rotational velocity U1 of the rotor 80, an angle component of the gas relative inflow velocity V can also be corrected by using an amount corresponding to the the angle α. Hence, as compared with the existing radial blade 160, the inclined blade 6 can suck a great amount of exhaust and can efficiently convert the exhaust into rotational energy.

A method for properly using the inclined blade 60 of the present implementation manner is explained below in detail.

For the radial blade 160 shown in FIG. 10(A), exhaust F2 is supplied by an exhaust supply port supply not shown in drawing in a manner of achieving an optimal angle of attack at a high flow rate. As shown in FIG. 10(B), after F3 whose exhaust flow rate has been reduced is supplied to the radial blade 160 at the same angle, a Cu3/U4 value is unfavorable.

In contrast, according to an angle of inclination a2 shown in FIG. 11(A), the inclined blade 60 is adjusted in manner of achieving an incidence angle relative to the exhaust F2 at a high flow rate. As shown in FIG. 11(B), in a case in which F3 whose exhaust flow rate has been reduced is supplied to the inclined blade 60 in the state, the Cu3/U6 value becomes unfavorable, but not as unfavorable as that of the radial blade 160.

On the other hand, in a case in which settings are performed in a manner of improving incidence angle of exhaust F4 at a low flow rate, a Cu5/U8 value of the radial blade 160 shown in FIG. 12(A), as shown in FIG. 12(B), becomes extremely unfavorable with respect to exhaust F5 at an intermediate flow rate.

In contrast, as shown in FIG. 13(A), the inclined blade 60 that is set by inclining by an angle α3 in a manner of improving incidence angle at a low flow rate is shown in FIG. 13(B), and even for exhaust F5 at an intermediate flow rate, a Cu5/U10 can still fall within an allowable range.

The turbine impeller 5 according to the present implementation manner would produce the following effects.

(1) The turbine impeller 5 of the present implementation manner is of the following structure: An exhaust flow route disposed on an internal combustion engine supplies high-pressure exhaust through a scroll flow route 42 and/or an exhaust supply port 49 of a fixed nozzle 46. The turbine impeller 5 includes a plurality of blade components 60, which converts exhaust convert exhaust into a rotational force; and a rotor 80, which is configured with the blade components 60 and can rotate by using a specified rotary shaft. In particular, a direction, relative to a gas relative inflow velocity of the rotor 80, specified by using the exhaust supply port 49 as a starting point and subtracting a rotational velocity component of the rotor 80 from a supply velocity component of the exhaust is set to not intersect with the rotary shaft of the rotor 80; and a shape, from a halfway portion 64 to a front edge portion 62, of the blade component 60 inclines, relative to a direction from a center of the rotor 80 to a front edge portion 62 of the blade component 60, toward front side of a rotational direction of the rotor 80 by a specified angle.

With regard to the turbine impeller 5 as stated above, an angle of inclination from the halfway portion 64 to the front edge portion 62 is adjusted to make incidence angle of exhaust that collides with the blade component become proper. In particular, the turbine impeller 5 that has a proper incidence angle for exhaust of different velocity zones can be formed by adjusting an angle α of the inclined blade 60.

As a result, because of a structural limitation, an incidence angle of an existing radial blade 160 cannot be properly designed, and the turbine impeller 5 of the present implementation manner can ensure a proper incidence angle for exhaust having different velocity zones, so as to provide a turbine impeller having high energy conversion efficiency.

(2) According to the turbine impeller of (1), an angle at which the exhaust flows into the blade component inclines by 10 degrees to 40 degrees relative to an angle formed between the gas relative inflow velocity and exhaust supplied by the exhaust supply port.

According to the turbine impeller of (1), with regard to the turbine impeller 5 of (2), in particular, an angle at which exhaust flows into the blade component 60 is set in a manner of inclining by 10 degrees to 40 degrees relative to an angle formed between the gas relative inflow velocity and the exhaust supplied by the exhaust supply port, so that a turbine impeller designed in a manner of achieving a proper angle of attack under a range of a low velocity to an intermediate velocity can be provided.

### Modified Example

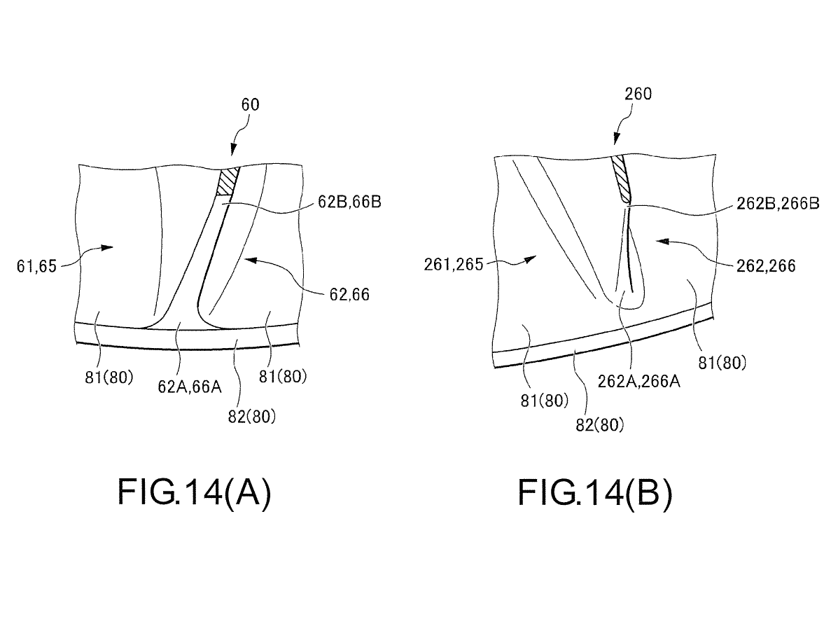

The turbine impeller 5 of the present implementation manner is explained in the foregoing, but a shape of the front edge portion 62 of the blade component 60 can be modified like a front edge portion 262 shown in FIG. 14(B). A turbine impeller 205 is specifically explained below by using accompanying drawings. FIG. 14(A) and FIG. 14(B) are three-dimensional diagrams for illustrating a modified example of a front edge portion of a turbine impeller according to the present implementation manner.

First, a plate-shaped component is mounted at the rotor 80 and machined into the blade component 60 shown in FIG. 14(A). Hence, a front end of the front edge portion 62 (66) of the blade component 60 is configured approximately the same as an outer circumferential surface 82 of the rotor 80 in a radial direction, and the front edge portion 62 is formed into a planar and angular shape.

Subsequently, a shaping process is performed on a connection portion (a blade root) between the blade hub surface side 62A and the blade hub surface 81 of the rotor 80 in a manner of making a round corner R, and a shaping process is performed in a manner of making a section from the blade hub surface side 62A to the shroud side (a thin sheet side) 62B present an approximately elliptical shape.

Hence, as shown in FIG. 14(B), the front edge portion 262 (266) is configured to be closer to an inner side in a radial direction than the outer circumferential surface 82. In addition, a section of the front edge portion 262 (266) is formed into an elliptical arc shape, and the front edge portion 262 (266) is smoothly curvedly formed in a manner of progressively reducing the thickness from a blade hub surface side 262A (266A) to a thin sheet surface side 262B (266B).

The front edge portion 262 and front edge portion 266 having the foregoing shape are respectively formed on a main blade 261 and an intermediate blade 265.

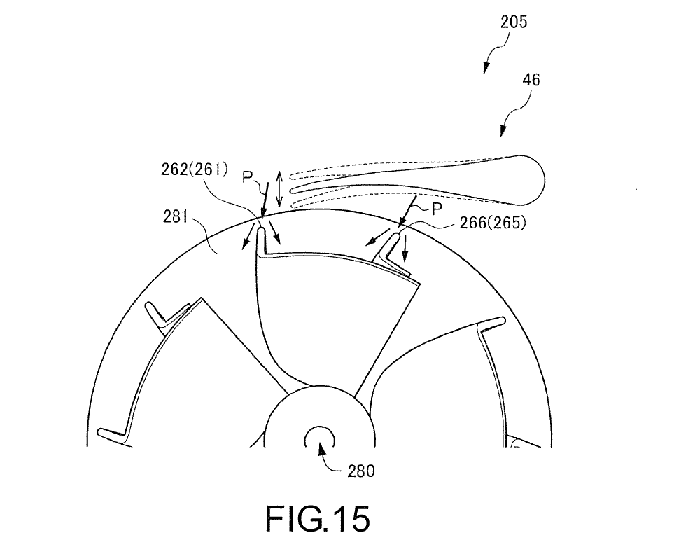

Functions based on the shape are explained by using FIG. 15.

FIG. 15 is a diagram for explaining functions of the modified example of the turbine impeller in FIG. 14.

With regard to the fixed nozzle 46 shown in FIG. 15, an exciting force P of a nozzle wake (a pressure change) generated by exhaust when passing through the interior of the fixed nozzle 46 is applied to the front ends of the front edge portion 262 and front edge portion 266 of each blade component. The exciting force P is properly distributed by the front edge portion 262 and front edge portion 266 that are in an approximately elliptical shape. Hence, a defect of the blade component caused by resonance of the nozzle wake can be prevented.

The turbine impeller 205 according to the modified example of the present implementation manner would produce the following effect.

(3) According to the turbine impeller of (1) or (2), sectional shapes of the front edge portion 262 and front edge portion 266 of the blade component 260 are formed into elliptical arc shapes.

According to the turbine impeller of (1) or (2), in the turbine impeller 205 of (3), each front edge portion is formed into an approximately circular shape with smooth curvature.

Hence, an exciting force that is formerly generated in a nozzle wake of the fixed nozzle 46 can be distributed by using a front end of the front edge portion.

Therefore, a turbine impeller that prevents a defect of the blade component caused by resonance of the nozzle wake and that gives consideration to both strength and aerodynamic performance of the blade component can be provided.

(4) According to the turbine impeller of (3), round corners R are formed at connection parts between the front edge portion 262 and front edge portion 266 of the blade component 260 and a blade hub 281 of the rotor 280, so that the thickness of the front edge portion 262 of the blade component 260 and the thickness of the front edge portion 266 of the blade component 260 respectively progressively reduce from blade hub surface sides 262A, 266A to thin sheet surface sides 262B, 266B of the blade component.

According to the turbine impeller of (3), in the turbine impeller 205 of (4), the round corner R is formed at the connection part of each front edge portion for connecting to the blade hub and is formed in a manner of progressively reducing the thickness from the blade hub side to the thin sheet side.

Hence, the front edge portion can further distribute the exciting force of the nozzle wake.

Therefore, an effect of (3) can be produced more specifically.

Further, the present invention is not limited to the implementation manner, and modifications, improvements, and the like in a scope in which the objective of the present invention can be achieved are included in the present invention.

For example, in the implementation manner, a case in which the turbine impeller of the present invention is applied to a supercharger utilizing exhaust of an internal combustion engine is explained, but the present invention is not limited thereto. In addition to a supercharger of an internal combustion engine, the present invention can also be applied to a so-called turbine machine, such as a jet engine or a jet pump, that performs conversion between energy of a fluid and mechanical energy by using an impeller.

What is claimed is:

1. A turbine impeller, which supplies a high-pressure fluid through a turbine scroll and/or a fluid supply port of a turbine nozzle, comprising:
a plurality of blade components, which converts the fluid into a rotational force; and
a rotor, which is configured with the blade components and is configured to rotate around a specified rotational axis, wherein:
a direction, relative to a gas relative inflow velocity of the rotor, specified by using the fluid supply port as a starting point and subtracting a rotational velocity component of the rotor from a supply velocity component of the fluid is set to not intersect with the rotational axis of the rotor; and
a shape, from a halfway portion to a front edge portion, of the blade component inclines, relative to a direction from a center of the rotor to the front edge portion of the blade component, toward front side of a rotational direction of the rotor by a specified angle.

2. The turbine impeller according to claim 1, wherein: an angle at which the fluid flows into the blade component inclines by 10 degrees to 40 degrees relative to an angle formed between the gas relative inflow velocity and exhaust supplied by the fluid supply port.

3. The turbine impeller according to claim 1, wherein a sectional shape of the front edge portion of the blade component is an elliptical arc shape.

4. The turbine impeller according to claim 2, wherein a sectional shape of the front edge portion of the blade component is an elliptical arc shape.

5. The turbine impeller according to claim 3, wherein a round corner that has a section in a circular arc shape and that smoothly connects a lateral surface of the blade component and a blade hub surface of the rotor is formed at a blade root of the front edge portion of the blade component; and
the thickness of the blade component progressively reduces from the rotor side to an edge of a thin sheet side.

6. The turbine impeller according to claim 4, wherein a round corner that has a section in a circular arc shape and that smoothly connects a lateral surface of the blade component and a blade hub surface of the rotor is formed at a blade root of the front edge portion of the blade component; and
the thickness of the blade component progressively reduces from the rotor side to an edge of a thin sheet side.
